(19) United States
(12) Patent Application Publication
(10) Pub. No.: US 2003/0080104 A1
(43) Pub. Date: May 1, 2003

(54) Heat treating apparatus and method

(75) Inventor: Tatsufumi Kusuda, Kyoto (JP)

Correspondence Address: OSTROLENK FABER GERB & SOFFEN, 1180 AVENUE OF THE AMERICAS, NEW YORK, NY, 100368403

(73) Assignee: Dainippon Screen Mfg. Co., Ltd.

(21) Appl. No.: 10/267,128

(22) Filed: Oct. 7, 2002

(30) Foreign Application Priority Data
Oct. 29, 2001 (JP) 2001-330229

(51) Int. Cl. F27D 11/00; H05B 3/68; F27B 5/14

(52) U.S. Cl. 219/390; 219/444.1

(57) ABSTRACT

A heat treating apparatus has an assist heating device for contacting and preheating a substrate, and a flash heating device for heating the substrate preheated by the assist heating device, to a treating temperature by irradiating the substrate with flashes of light. The assist heating device includes a heating plate having a heater, and a thermal diffuser plate formed of quartz and disposed on a surface of the heating plate opposed to the substrate. The surface of the heating plate with the thermal diffuser plate disposed thereon is formed of white aluminum nitride.

### BACKGROUND OF THE INVENTION

1. Field of the Invention

The present invention relates to a heat treating apparatus and method for heat treating substrates such as semiconductor wafers by irradiating the substrates with light.

2. Description of the Related Art

A heat treating apparatus such as a lamp annealing apparatus with halogen lamps is used to execute a step of activating ions implanted in a semiconductor wafer. Such a heat treating apparatus activates ions in the semiconductor wafer by heating the wafer to a temperature of about 1,000 to 1,100 degC., for example. Then, the heat treating apparatus heats the wafer at a rate of some several hundred degrees per second by using the energy of light emitted from the halogen lamps.

However, it has been found that, even when ions in the semiconductor wafer are activated by using the heat treating apparatus that heats the wafer at the rate of several hundred degrees per second, the ions implanted in the semiconductor wafer present a blunt profile, that is the ions become dispersed. When such a phenomenon occurs, the ions become dispersed even though implanted in high concentration into the surface of the semiconductor wafer, and hence a problem of having to implant the ions in a larger amount than is necessary.

To solve the above problem, it is conceivable to use xenon flashlamps, for example, to irradiate the surface of the semiconductor wafer with flashes, thereby to heat, within an extremely short time, only the surface of the semiconductor wafer implanted with ions. However, although the surface of the semiconductor wafer may be heated very quickly by using xenon flashlamps, the wafer is heated only to 500 degrees or thereabouts. It is impossible to heat the semiconductor wafer to the temperature of about 1,000 to 1,100 degC. necessary for activating the ions in the wafer.

On the other hand, Japanese Patent Publication (Unexamined) No. 2001-237195, by way of addressing the above problem, discloses a heat treating apparatus having a preheating device for preheating a substrate before heating the substrate by xenon flashlamps.

The above heat treating apparatus uses, as the preheating device, a heating plate with a built-in heater or light sources such as halogen lamps. Where the heating plate is used, an adjustment to heat a substrate uniformly is easier than where the light sources such as halogen lamps are used.

However, even where the heating plate is used, it has become difficult to heat the substrate with a sufficiently high degree of uniformity required in recent years. For the substrate heated with only an insufficient degree of uniformity, high quality cannot be secured with high precision.

### SUMMARY OF THE INVENTION

The object of the present invention, therefore, is to provide a heat treating apparatus for heat treating substrates with a sufficiently high degree of uniformity.

The above object is fulfilled, according to the present invention, by a heat treating apparatus having an assist heating device for contacting and preheating a substrate, and a flash heating device for heating the substrate preheated by the assist heating device, to a treating temperature by irradiating the substrate with flashes of light, the assist heating device comprising a heating plate having a heater, and a thermal diffuser plate disposed on a surface of the heating plate opposed to the substrate, the thermal diffuser plate having a smaller coefficient of thermal conductivity than the heating plate. With this heat treating apparatus, the substrate may be heat treated with a sufficient degree of uniformity.

In a preferred embodiment of the invention, the thermal diffuser plate is formed of quartz. With this construction, the substrate may be heat treated uniformly without being contaminated.

Preferably, the surface of the heating plate with the thermal diffuser plate disposed thereon is formed of white aluminum nitride. This is effective to avoid burning of the heating plate.

In another aspect of the invention, there is provided a heat treating apparatus having an assist heating device for contacting and preheating a substrate, and a flash heating device for heating the substrate preheated by the assist heating device, to a treating temperature by irradiating the substrate with flashes of light, the assist heating device comprising a heater mounted therein, a surface of the assist heating device for contacting the substrate being formed of quartz.

In a further aspect of the invention, there is provided a heat treating method comprising an assist heating step for contacting and preheating a substrate, and a flash heating step for heating the substrate preheated in the assist heating step, to a treating temperature by irradiating the substrate with flashes of light, wherein the assist heating step is executed to preheat the substrate by using a heating device including a heating plate having a heater, and a thermal diffuser plate disposed on a surface of the heating plate opposed to the substrate, the thermal diffuser plate having a smaller coefficient of thermal conductivity than the heating plate.

Other features and advantages of the present invention will be apparent from the following detailed description of the embodiment of the invention.

### BRIEF DESCRIPTION OF THE DRAWINGS

For the purpose of illustrating the invention, there are shown in the drawings several forms which are presently preferred, it being understood, however, that the invention is not limited to the precise arrangement and instrumentalities shown.

FIG. 1 is a sectional side view of a heat treating apparatus according to the invention;

FIG. 2 is a sectional side view of the heat treating apparatus;

FIG. 3 is a schematic plan view of the heat treating apparatus;

FIG. 4 is an enlarged side view of a portion of a thermal diffuser plate;

FIG. 5 is a flow chart showing a semiconductor wafer heat treating operation of the heat treating apparatus according to the invention; and

FIG. 6 is a graph showing changes in the temperature of the semiconductor wafer.

### DESCRIPTION OF THE PREFERRED EMBODIMENT

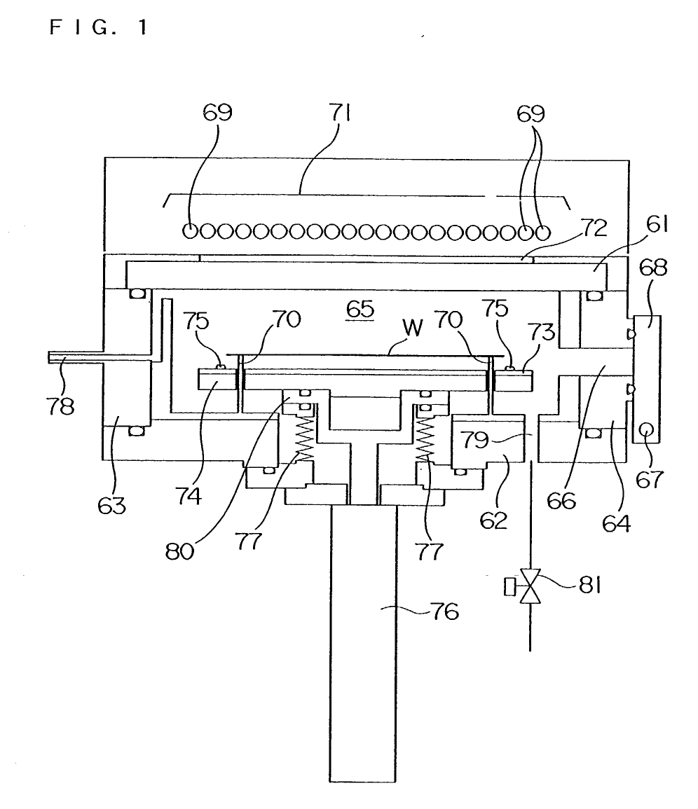

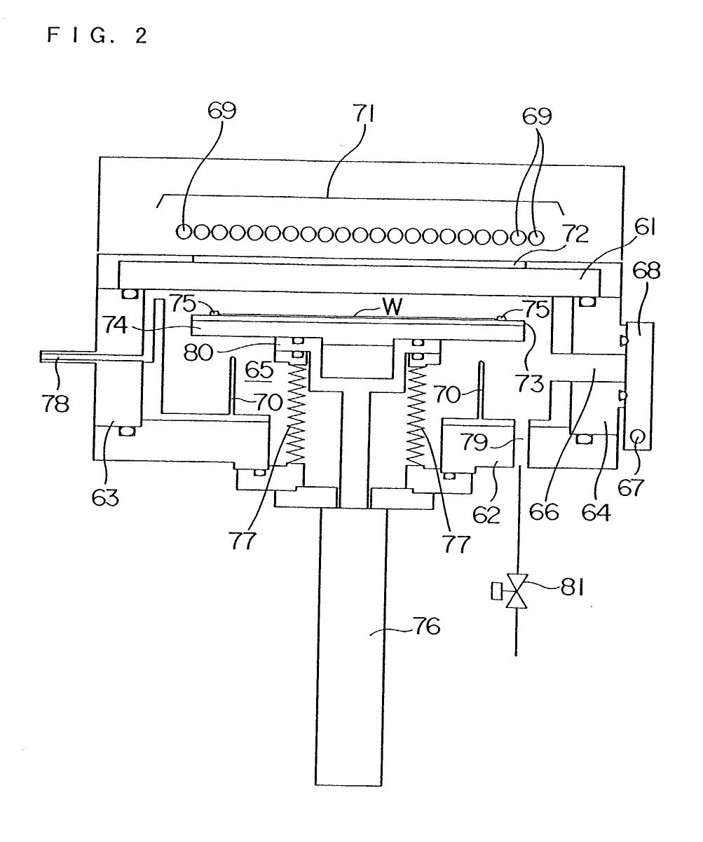

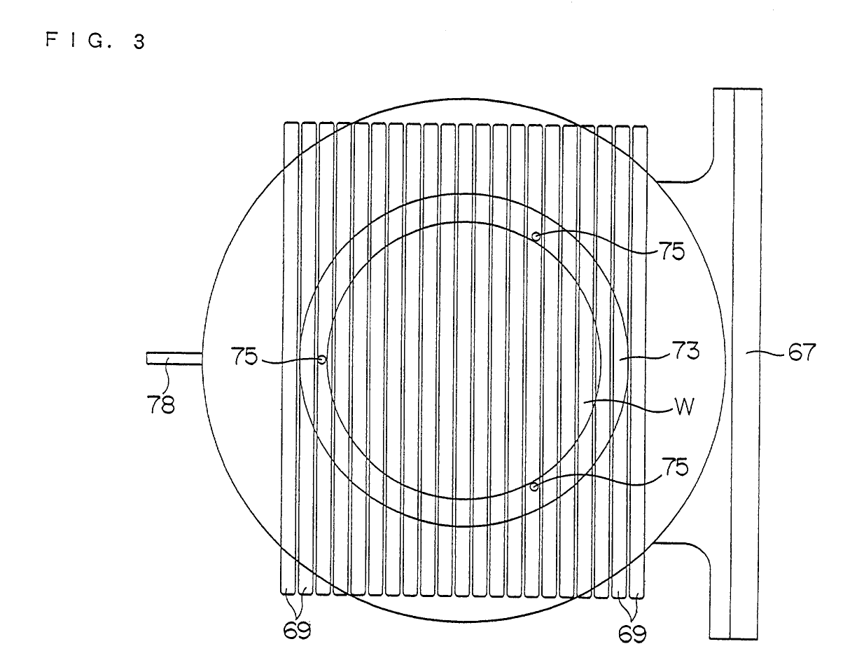

An embodiment of the present invention will be described hereinafter with reference to the drawings. FIGS. 1 and 2 are sectional side views of a heat treating apparatus according to the invention. FIG. 3 is a schematic plan view of the apparatus.

This heat treating apparatus includes a heat treating chamber 65 having a translucent plate 61, a bottom plate 62 and a pair of side plates 63 and 64 for receiving and heat treating a semiconductor wafer W. The translucent plate 61 acting as part of the heat treating chamber 65 is formed of an infrared transmitting material such as quartz. The bottom plate 62 acting as part of the heat treating chamber 65 has support pins 70 erected thereon and extending through a thermal diffuser plate 73 and a heating plate 74 to be described hereinafter, for supporting the semiconductor wafer W at the lower surface thereof.

The side plate 64 acting as part of the heat treating chamber 65 defines an opening 66 for loading and unloading the semiconductor wafer W. The opening 66 is closable by a gate valve 68 pivotable about an axis 67. With the opening 66 opened, the semiconductor wafer W is loaded into the heat treating chamber 65 by a transport robot not shown.

A plurality of (21 in this embodiment) cylindrical xenon flashlamps 69 are arranged parallel to one another above the heat treating chamber 65. A reflector 71 is disposed above the xenon flashlamps 69.

Each xenon flashlamp 69 includes a glass tube filled with xenon gas and having an anode and a cathode disposed at opposite ends thereof and connected to a capacitor, and a trigger electrode wound around the glass tube. Since xenon gas is an electrical insulator, electricity does not flow through the glass tube in a normal state. However, when the insulation is broken by applying a high voltage to the trigger electrode, electricity stored in the capacitor flows through the glass tube. This generates Joule heat which heats the xenon gas, thereby emitting light. In the xenon flashlamps 69, electrostatic energy stored is converted into extremely short light pulses of 0.1 to 10 milliseconds. Thus, the xenon flashlamps 69 are characterized by their capability of emitting extremely strong light compared with continuously lit light sources.

A light diffuser plate 72 is disposed between the xenon flashlamps 69 and translucent plate 61. The light diffuser plate 72 is formed of quartz glass which is an infrared transmitting material with surfaces thereof given light diffusion treatment.

The heat treating chamber 65 has the thermal diffuser plate 73 and heating plate 74 arranged in the stated order therein. The thermal diffuser plate 73 has pins 75 provided on the upper surface thereof for holding the semiconductor wafer W against displacement.

The heating plate 74 is provided for preheating the semiconductor wafer W. This heating plate 74 is formed of white aluminum nitride. The heating plate 74 contains a heater and a sensor for controlling the heater. The heating plate 74 need not be formed entirely of white aluminum nitride, but only the surface thereof opposed to the thermal diffuser plate 73 may be formed of white aluminum nitride.

With white aluminum nitride used for forming the surface of the heating plate 74 opposed to the thermal diffuser plate 73 as noted above, the heating plate 74 is prevented from burning in time of flash exposure described hereinafter. However, the heating plate 74 may be formed of non-white aluminum nitride or silicon carbide (SiC).

The thermal diffuser plate 73 is provided for diffusing thermal energy from the heating plate 74 to heat the semiconductor wafer W uniformly. The thermal diffuser plate 73 is formed of a material having a smaller coefficient of thermal conductivity than the heating plate 74.

Specifically, the thermal diffuser plate 73 may be formed of quartz which has a moderate coefficient of thermal conductivity and which never contaminates the semiconductor wafer W. Instead of quartz, sapphire which is an aluminum oxide may be used.

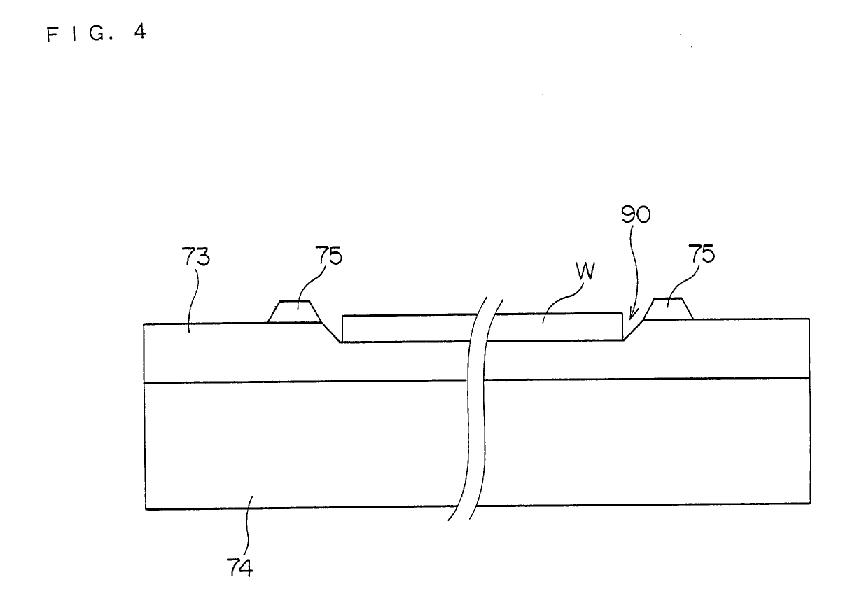

FIG. 4 is an enlarged side view of a portion of the thermal diffuser plate 73.

As shown in FIG. 4, the thermal diffuser plate 73 has a recess 90 formed in the surface thereof to have a shape corresponding to the outside diameter of semiconductor wafer W. The recess 90 has a depth substantially corresponding to the thickness of wafer W, and this depth is not depicted in FIGS. 1 through 3. The wafer W is positioned in the recess 90 and held against displacement by the positioning pins 75 noted hereinbefore. The recess 90 and positioning pins 75 constitute a positioning device for the wafer W. It is possible to omit either the recess 90 or positioning pins 75.

Referring again to FIGS. 1 through 3, the thermal diffuser plate 73 and heating plate 74 are driven by an air cylinder 76 to move vertically between a position shown in FIG. 1 for loading and unloading the semiconductor wafer W, and a position shown in FIG. 2 for heat treating the wafer W.

The thermal diffuser plate 73 and heating plate 74 are lowered to the position shown in FIG. 1 for loading and unloading the semiconductor wafer W. In this position, the transport robot not shown is used to carry the semiconductor wafer W in through the opening 66 and place the wafer W on the support pins 70, or to remove the wafer W from the support pins 70 and carry the wafer W out through the opening 66. In this state, upper ends of the support pins 70 extend through bores formed in the thermal diffuser plate 73 and heating plate 74, and project upward from the surface of thermal diffuser plate 73. For expediency of description, FIG. 1 shows the bores in the thermal diffuser plate 73 and heating plate 74 which actually are invisible in side view.

The thermal diffuser plate 73 and heating plate 74 are raised to the position shown in FIG. 2, in which the two plates 73 and 74 are above the upper ends of support pins 70, for heat treating the semiconductor wafer W. In this state, the semiconductor wafer W is raised, with the lower surface thereof supported by the upper surface of thermal diffuser plate 73, to the position close to the translucent plate 61.

Particles may be generated when the thermal diffuser plate 73 and heating plate 74 are moved up and down between the loading and unloading position and the heat treating position. In order to prevent such particles from adhering to the semiconductor wafer W, a bellows 77 is disposed to extend between a support member 80 supporting the heating plate 74 and the bottom plate 62 of heat treating chamber 65.

An intake passage 78 is formed in the side wall 63 remote from the opening 66 of the heat treating chamber 65. This intake passage 78 is provided to introduce air in time of opening the chamber 65 to the atmosphere to be described hereinafter. Instead of air, nitrogen gas or other gas may be introduced.

The bottom plate 62 of heat treating chamber 65 defines an exhaust port 79. This exhaust port 79 is connected to a decompression mechanism such as a vacuum pump through a switch valve 81. The exhaust port 79 and switch valve 81 constitute the decompression device of the present invention.

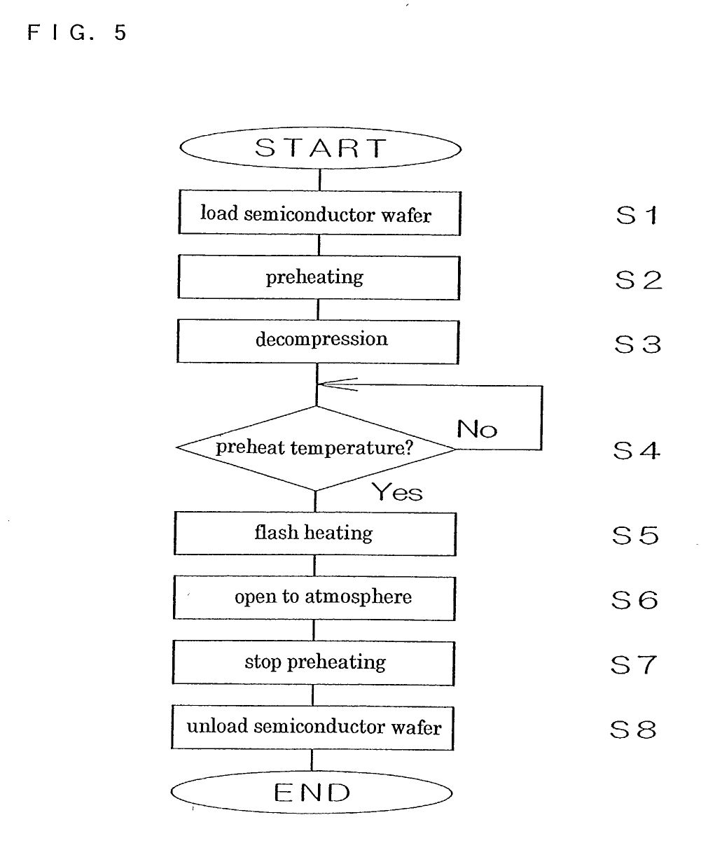

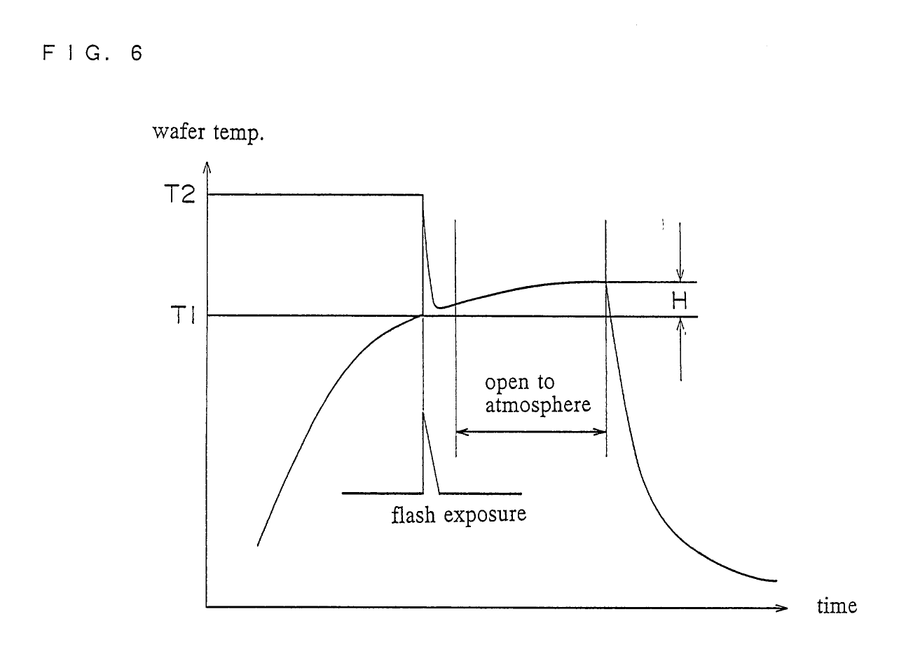

An operation of the heat treating apparatus for heat treating the semiconductor wafer W according to the invention will be described next. FIG. 5 is a flow chart showing the operation for heat treating the semiconductor wafer W by the heat treating apparatus according to the invention. FIG. 6 is a graph showing changes in the temperature of the semiconductor wafer W.

In this heat treating apparatus, with the thermal diffuser plate 73 and heating plate 74 lowered to the position shown in FIG. 1 for loading and unloading the semiconductor wafer W, the transport robot not shown carries the semiconductor wafer W in through the opening 66 and places the wafer W on the support pins 70. Upon completion of the wafer loading operation, the opening 66 is closed by the gate valve 68 (step S1). Subsequently, the thermal diffuser plate 73 and heating plate 74 are raised by the air cylinder 76 to the position shown in FIG. 2 for heat treating the semiconductor wafer W.

The thermal diffuser plate 73 and heating plate 74 have been heated by the heater mounted in the heating plate 74. Thus, with the thermal diffuser plate 73 and heating plate 74 raised to the heat treating position shown in FIG. 2, the semiconductor wafer W is preheated by through contact with the hot thermal diffuser plate 73. The temperature of wafer W gradually increases as shown in FIG. 6 (step S2).

In this preheating step, the wafer W receives thermal energy from the heating plate 74 through the thermal diffuser plate 73. Consequently, the wafer W may be heated uniformly even when the heating plate 74 has a temperature distribution not entirely uniform.

In parallel with the preheating step, the heat treating chamber 65 is decompressed (step S3). That is, the switch valve 81 is opened to connect the intake passage 78 to the decompression mechanism not shown, thereby purging and decompressing the heat treating chamber 65. Preferably, the heat treating chamber 65 is decompressed to 1/10 to 1/1000 atmospheric pressure to produce various advantageous effects to be described hereinafter.

In this state, the semiconductor wafer W continues to be heated through the thermal diffuser plate 73. In time of temperature increase, the surface temperature of semiconductor wafer W is constantly monitored by a temperature sensor not shown, to determine whether the surface has reached a preheat temperature T1 (step S4).

The preheat temperature T1 is in a range of about 200 to 600 degC. Even if the semiconductor wafer W is heated to such preheat temperature T1 , the ions implanted in the wafer W remain unchanged, i.e. are never dispersed.

Immediately after the surface temperature of semiconductor wafer W reaches the preheat temperature T1 in FIG. 6, the xenon flashlamps 69 are lit for flash heating (step S5). The lighting time of the xenon flashlamps 69 in this flash heating step is about 0.1 to 10 milliseconds. In this way, the electrostatic energy prestored in the xenon flashlamps 69 is converted into such an extremely short light pulse. This results in very strong flashes being emitted.

In this state, the surface temperature of semiconductor wafer W reaches temperature T2 in FIG. 6. This temperature T2 is about 1,000 to 1,100 degC., i.e. a temperature necessary for treating the semiconductor wafer W. When the surface of semiconductor wafer W is heated to this treating temperature T2, the ions in the wafer W are activated.

The surface of semiconductor wafer W is heated to the treating temperature T2 in the extremely short time of about 0.1 to 10 milliseconds. Consequently, the activation of the ions in the semiconductor wafer W is completed in a short time. This prevents the ions implanted in the semiconductor wafer W from becoming dispersed to present a blunt profile.

As noted above, before lighting the xenon flashlamps 69 to heat the semiconductor wafer W, the heating plate 74 is used to raise the surface temperature of semiconductor wafer W to the preheat temperature T1 of about 200 to 600 degC. The semiconductor wafer W may therefore be heated by the xenon flashlamps 21 quickly to the treating temperature T2 of about 1,000 to 1,100 degC.

In this flash heating step, the heating plate 74 is subjected to rays transmitted through the thermal diffuser plate 73 formed of quartz. However, the heating plate 74 formed of white aluminum nitride is never burnt.

The above flash heating step is executed under the decompressed condition. This step therefore is executed free from a reaction of the gas in the heat treating chamber 65 which could scatter particles and move the semiconductor wafer W, as in the prior art.

Similarly, by decompressing the heat treating chamber 65, no convection occurs in the heat treating chamber. Consequently, the surface of semiconductor wafer W may be heated uniformly in the preheating step and flash heating step.

Further, by decompressing the heat treating chamber 65, oxygen and organic substances may be excluded from the heat treating chamber 65. This avoids a reduction in the life of the heat treating apparatus due to oxidation of the materials forming the heat treating chamber 65 or melanization of organic substances.

After the flash heating step, the switch valve 81 is closed and air is introduced through the intake passage 78 to open the heat treating chamber 65 to the atmosphere (step S6). The semiconductor wafer W stops being heated by the heating plate 74 (step S7).

As noted above, flash heating is carried out immediately after the surface temperature of semiconductor wafer W reaches the preheat temperature T1. Upon completion of the flash heating step, the heat treating chamber 65 is opened to the atmosphere. These steps are taken for the following reason.

In the heat treating apparatus according to the invention, the heating plate 74 is installed in the decompressed heat treating chamber 65. It is therefore difficult to cool the heating plate 74 and to maintain the heating plate 74 at a desired temperature. Where this problem is addressed by using a cooling device such as Peltier elements, the semiconductor wafer W will have reduced temperature uniformity.

The heat treating apparatus according to the invention, therefore, carries out flash heating immediately after the surface temperature of semiconductor wafer W reaches the preheat temperature T1, avoiding the flash heating being carried out when the semiconductor wafer W becomes heated above the preheat temperature T1. After the flash heating step, the heat treating chamber 65 is opened to the atmosphere to cool its interior. Consequently, as shown in FIG. 6, the temperature of semiconductor wafer W lowers quickly after slightly overshooting (as at H) the preheat temperature T1.

After completion of the opening to the atmosphere of the heat treating chamber 65, the air cylinder 76 lowers the thermal diffuser plate 73 and heating plate 74 to the position shown in FIG. 1 for loading and unloading the semiconductor wafer W. The opening 66 that has been closed by the gate valve 68 is opened. The transport robot not shown removes the semiconductor wafer W resting on the support pins 70 and carries the wafer W out of the apparatus (step S8).

The above embodiment uses the heating plate 74 as the preheating device. Instead, lamps such as halogen lamps may be used as the preheating device.

The present invention may be embodied in other specific forms without departing from the spirit or essential attributes thereof and, accordingly, reference should be made to the appended claims, rather than to the foregoing specification, as indicating the scope of the invention.

This application claims priority benefit under 35 U.S.C. Section 119 of Japanese Patent Application No. 2001-330229 filed in the Japanese Patent Office on Oct. 29, 2001, the entire disclosure of which is incorporated herein by reference.

What is claimed is:

1. A heat treating apparatus having assist heating means for contacting and preheating a substrate, and flash heating means for heating the substrate preheated by the assist heating means, to a treating temperature by irradiating the substrate with flashes of light, said assist heating means comprising:
a heating plate having a heater; and
a thermal diffuser plate disposed on a surface of said heating plate opposed to the substrate, said thermal diffuser plate having a smaller coefficient of thermal conductivity than said heating plate.

2. A heat treating apparatus as defined in claim 1, wherein said thermal diffuser plate is formed of quartz.

3. A heat treating apparatus as defined in claim 2, wherein said surface of said heating plate with said thermal diffuser plate disposed thereon is formed of aluminum nitride.

4. A heat treating apparatus as defined in claim 3, wherein said aluminum nitride is white at least in a surface thereof opposed to said thermal diffuser plate.

5. A heat treating apparatus as defined in claim 2, wherein said thermal diffuser plate has substrate positioning means formed in/on a surface thereof.

6. A heat treating apparatus as defined in claim 5, wherein said positioning means comprises a recess formed in said thermal diffuser plate.

7. A heat treating apparatus as defined in claim 5, wherein said positioning means comprises pins formed on said thermal diffuser plate.

8. A heat treating apparatus as defined in claim 2, wherein said flash heating means comprises xenon flashlamps.

9. A heat treating apparatus as defined in claim 2, wherein said assist heating means is arranged to preheat the substrate to 200 to 600 degrees centigrade.

10. A heat treating apparatus as defined in claim 9, wherein said flash heating means is arranged to heat the substrate to 1,000 to 1,100 degrees centigrade.

11. A heat treating apparatus as defined in claim 2, further comprising decompression means for decompressing, when said flash heating means heats the substrate, a heat treating chamber in which the substrate is placed.

12. A heat treating apparatus having assist heating means for contacting and preheating a substrate, and flash heating means for heating the substrate preheated by the assist heating means, to a treating temperature by irradiating the substrate with flashes of light,
said assist heating means comprising a heater mounted therein, a surface of said assist heating means for contacting the substrate being formed of quartz.

13. A heat treating apparatus as defined in claim 12, wherein said flash heating means comprises xenon flashlamps.

14. A heat treating apparatus as defined in claim 13, wherein said assist heating means is arranged to preheat the substrate to 200 to 600 degrees centigrade.

15. A heat treating apparatus as defined in claim 14, wherein said flash heating means is arranged to heat the substrate to 1,000 to 1,100 degrees centigrade.

16. A heat treating apparatus as defined in claim 12, further comprising decompression means for decompressing said heat treating chamber when said flash heating means heats the substrate.

17. A heat treating method comprising an assist heating step for contacting and preheating a substrate, and a flash heating step for heating the substrate preheated in the assist heating step, to a treating temperature by irradiating the substrate with flashes of light;
wherein said assist heating step is executed to preheat the substrate by using heating means including a heating plate having a heater, and a thermal diffuser plate disposed on a surface of said heating plate opposed to the substrate, said thermal diffuser plate having a smaller coefficient of thermal conductivity than said heating plate.

18. A heat treating method as defined in claim 17, wherein said flash heating step is executed to heat the substrate to the treating temperature by irradiating the substrate with flashes of light immediately after the substrate is preheated to a predetermined preheat temperature.

19. A heat treating method as defined in claim 17, wherein said flash heating step is executed to heat the substrate by using xenon flashlamps.

20. A heat treating method as defined in claim 17, wherein said assist heating step is executed to preheat the substrate to 200 to 600 degrees centigrade.

21. A heat treating method as defined in claim 17, wherein said flash heating step is executed to heat the substrate to 1,000 to 1,100 degrees centigrade.
